(19) United States
(12) Patent Application Publication
(10) Pub. No.: US 2010/0271399 A1
(43) Pub. Date: Oct. 28, 2010

(54) ELECTRONIC DEVICE AND METHOD FOR POSITIONING OF AN IMAGE IN THE ELECTRONIC DEVICE

(75) Inventor: JIUE-ROU SHIU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/612,747

(22) Filed: Nov. 5, 2009

(30) Foreign Application Priority Data
Apr. 23, 2009 (CN) 200910301774.7

(51) Int. Cl. G09G 5/00

(52) U.S. Cl. 345/660; 382/164

(57) ABSTRACT

An electronic device and a method for positioning of an image in the electronic device are provided. The electronic device can compute RGB values of each pixel of the image, and cluster the image to a foreground cluster and a background cluster based on the RGB values. The foreground cluster is segmented into at least one foreground figure. If a selected foreground figure is magnified, the image is magnified, a center coordinate of the selected foreground figure is mapped to the center of a display screen of the electronic device, so as to position the magnified image.

### BACKGROUND

1. Technical Field

Embodiments of the present disclosure generally relate to an electronic device and a display method used in the electronic device, and more particularly to a method for positioning an image in the electronic device.

2. Description of Related Art

A display screen of an electronic device, has a limited display area. The limited display area may cause a user much inconvenience to browse an image displayed on the display screen. For example, the displayed image may exceed the display area. In another example, the user magnifying the image using a magnification feature of the electronic device, may cause the magnified image to exceed the display area, causing the user to move the magnified image upwards, move downwards, move left, or move right, so as to position the magnified image on the display screen. In order to overcome the shortcomings, a sensing device may be included in the electronic device to properly position the magnified image. However, inclusion of the sensing device adds increased cost.

What is needed, therefore, is a display method used in the electronic device, so as to overcome the above-mentioned problems.

### BRIEF DESCRIPTION OF THE DRAWINGS

FIG. 1 is a block diagram of one embodiment of an electronic device for positioning of an image to be magnified.

FIG. 2 is a block diagram of function modules of an adjusting unit included in the electronic device of FIG. 1.

FIG. 3 is a schematic diagram of one embodiment of image clustering and segmentation.

FIG. 4 is a flowchart illustrating one embodiment of a method for positioning of an image to be magnified in an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

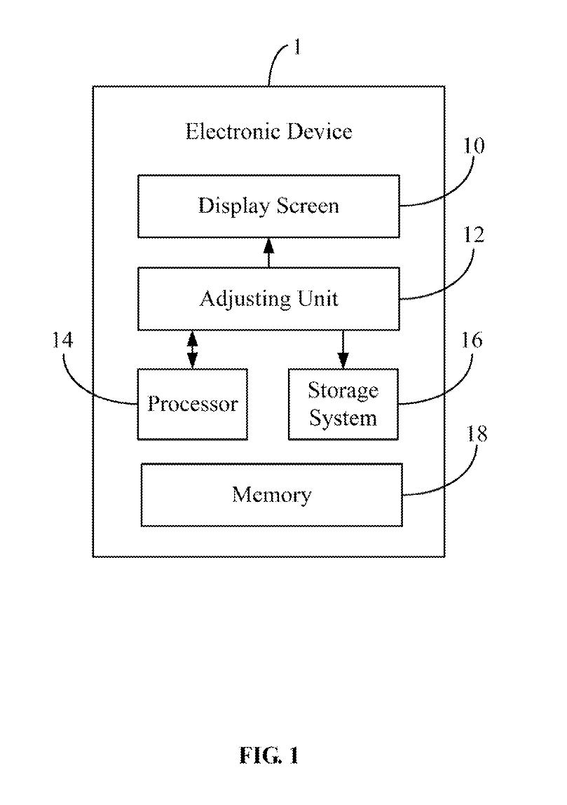

FIG. 1 is a block diagram of one embodiment of an electronic device 1 comprising an adjusting unit 12. The adjusting unit 12 may be used to dynamically magnify an image when a user is browsing a displayed image on a display screen 10 of the electronic device 1. In one embodiment, the electronic device 1 may be a mobile phone, a personal digital assistant, a personal computer, a personal digital assistant, a camera or a game machine that comprises the display screen 10. The electronic device 1 further includes at least one processor 14, a storage system 16, and a memory 18. One or more computerized codes of the adjusting unit 12 may be stored in the storage system 16, and can be executed by the at least one processor 14 of the electronic device 1. The storage system 16 may be a hard disk drive, a compact disc, a digital video disc, or a tape drive, for example.

The memory 18 is configured for storing a plurality of image files. In the embodiment, the memory 18 may be a smart media card, a secure digital card, a compact flash card, a multi-media card, a memory stick, an extreme digital card or a trans flash card.

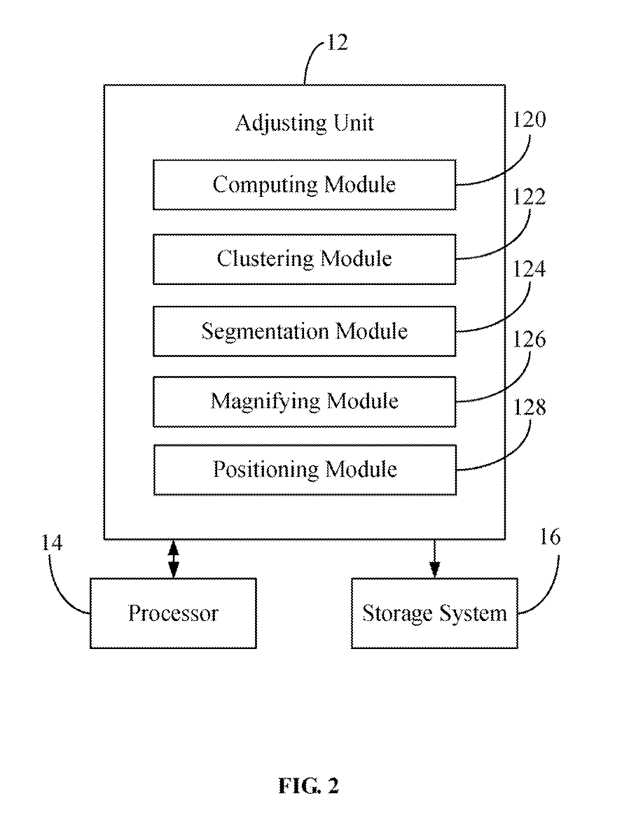

The display screen 10 is configured for displaying an image when a user browses the displayed image. Because a display area of the display screen 10 is limited, the adjusting unit 12 is operable to adjust a display position of the displayed image that exceeds the display area of the display screen 10. In another embodiment, the adjusting unit 12 is operable to adjust a display position of a magnified image displayed on the display screen 10. The adjusting method is detailed in FIG. 2 to FIG. 4.

FIG. 2 is a block diagram of function modules of the adjusting unit 12 included in the electronic device 1. The adjusting unit 12 may include a plurality of instructions executed by the at least one processor 16. In one embodiment, the adjusting unit 12 may include a computing module 120, a clustering module 122, a segmentation module 124, a magnifying module 126, and a positioning module 128.

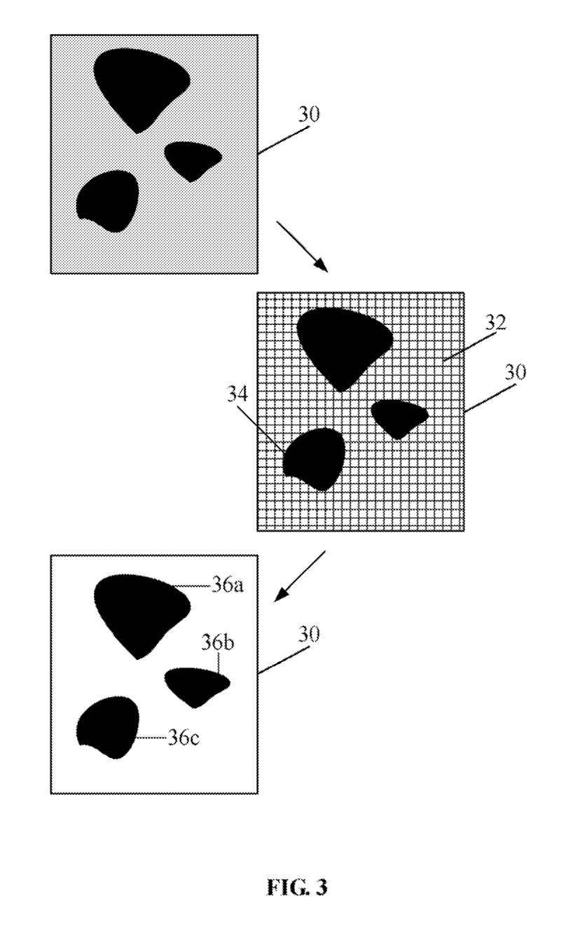

After an image 30 (as shown in FIG. 3) is selected from the memory 18, the computing module 120 is operable to compute red, green, blue (RGB) values for each pixel of the selected image 30. The RGB values can be treated as variables for image clustering, and may include red values, green values and blue values for each pixel. In the embodiment, the selected image 30 may include a plurality of foreground figures (only three foreground figures are shown in FIG. 3). Each of the plurality of foreground figures can be uniquely referenced by coordinate values relative to the selected image 30.

The clustering module 122 is operable to identify a foreground cluster 32 from a background cluster 34 based on the RGB values using a mixture model. As described in FIG. 3, the clustering module 122 groups pixels of the selected image 30 into two clusters based on the RGB values according to the mixture model. The clusters include the foreground cluster 32 and the background cluster 34. The clustering module 122 separates the foreground cluster 32 from the background cluster 34.

In the embodiment, the mixture model may use an expectation—maximization algorithm for clustering the selected image 30. The expectation—maximization algorithm includes: calculating a first similarity ratio between each pixel of the selected image 30 and the foreground cluster 32, and a second similarity ratio between each pixel of the selected image 30 and the background cluster 34, sorting each pixel of the selected image 30 into the foreground cluster 32 or the background cluster 34 according to the similarity ratios, and adjusting each pixel of the selected image 30 to sort the each pixel into a most possible cluster.

The segmentation module 124 is operable to segment the foreground cluster 32 to obtain at least one foreground figure included in the selected image 30 (see the foreground figures “36a,” “36b” and “36c” shown in FIG. 3), according to the particular coordinate value of each of the at least one foreground figure. In the embodiment, the segmentation module 124 uses a nearest neighborhood algorithm to compute a distance between each two pixels of the selected image 30, and determine one foreground figure for each pixel in the foreground cluster. For example, the segmentation module 124 determines the foreground figure “36a” for a pixel “N,” the pixel “N” is enclosed by the foreground figure “36a.”

In the embodiment, the computing module 120 is further operable to compute a center coordinate and a total area for each of the at least one foreground figure.

The magnifying module 126 invokes a magnification feature of the electronic device 1 to magnify the selected image 30 at a foreground figure selected from the at least one foreground figure according to user input. The positioning module 128 is operable to position the magnified image by mapping the center coordinate of a selected foreground figure to the center of the display screen 10. In one embodiment, the foreground figure who has a largest total area is the selected foreground figure by default, such as the foreground FIG. 36a in FIG. 3. In another embodiment, the foreground figure who has a smallest total area is the selected foreground figure by default, such as the foreground FIG. 36b in FIG. 3.

In another embodiment, the positioning module 128 is further operable to adjust a display position of a displayed image that exceeds the display area of the display screen 10.

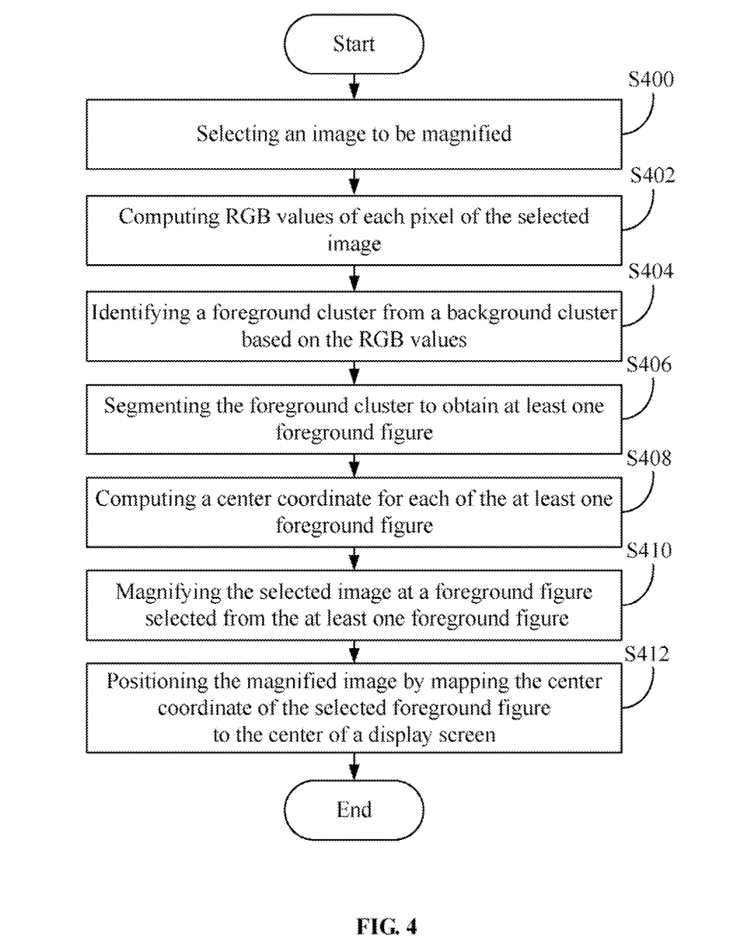

FIG. 4 is a flowchart illustrating one embodiment of a flowchart illustrating one embodiment of a method for positioning of an image in the electronic device 1. Depending on the embodiment, additional blocks in the flow of FIG. 4 may be added, others removed, and the ordering of the blocks may be changed.

In block S400, an image 30 to be magnified is selected and the display screen 10 displays the selected image 30.

In block S402, the computing module 120 computes RGB values of each pixel of the selected image 30. The selected image 30 may include a plurality of foreground figures (only three foreground figures are shown in FIG. 3). Each of the plurality of foreground figures can be uniquely referenced by coordinate values relative to the selected image 30.

In block S404, the clustering module 122 identifies a foreground cluster 32 from a background cluster 34 based on the RGB values according to a mixture model. As described in FIG. 3, the clustering module 122 uses the mixture model to group pixels of the selected image into either the foreground cluster and the background cluster based on the RGB values.

In block S406, the segmentation module 124 segments the foreground cluster 34 to obtain at least one foreground figure according to the particular coordinate value of each of the at least one foreground figure, such as the foreground figure “36a,” “36b” and “36c” in FIG. 3.

In block S408, the computing module 120 computes a center coordinate for each of the at least one foreground figure.

In block S410, the magnifying module 126 invokes a magnification feature of the electronic device 1 to magnify the selected image at a foreground figure selected from the at least one foreground figure according to user input.

In block S412, the positioning module 128 positions the magnified image by mapping the center coordinate of the selected foreground figure to the center of the display screen 10.

In the embodiment, the computing module 120 further computes a total area for each of the at least one foreground figure, the foreground figure who has a largest or smallest total area may be the selected foreground figure by default. In another embodiment, the block S408 can be executed after the block S410.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for positioning an image to be magnified on a display screen of an electronic device, the method comprising:
computing red green blue (RGB) values of each pixel of the image, the image comprising a plurality of foreground figures and each of the plurality of foreground figures uniquely referenced by coordinate values relative to the image;
using a mixture model to identify a foreground cluster from a background cluster based on the RGB values;
segmenting the foreground cluster to obtain at least one foreground figure based on the particular coordinate value of each of the at least one foreground figure;
invoking a magnification feature of the electronic device to magnify the image at a foreground figure selected from the at least one foreground figure; and
positioning the magnified image by mapping a center coordinate of the selected foreground figure to the center of the display screen.

2. The method as described in claim 1, wherein the mixture model is an expectation—maximization algorithm to cluster the image, and the expectation—maximization algorithm includes:
calculating a first similarity ratio between each pixel of the image and the foreground cluster, and a second similarity ratio between each pixel of the image and the background cluster;
sorting each pixel of the image into the foreground cluster or the background cluster according to the similarity ratios; and
adjusting each pixel of the image to sort the each pixel into a most possible cluster.

3. The method as described in claim 1, further comprising:
computing a center coordinate and a total area for each of the at least one foreground figure.

4. The method as described in claim 3, wherein the foreground figure who has a largest total area is the selected foreground figure by default.

5. The method as described in claim 3, wherein the foreground figure who has a smallest total area is the selected foreground figure by default.

6. The method as described in claim 1, wherein the electronic device is a mobile phone, a personal digital assistant, a camera or a video camera.

7. A storage medium having stored thereon instructions that, when executed by a processor, causing the processor to position an image to be magnified on a display screen of an electronic device, wherein the method comprises:
computing red green blue (RGB) values of each pixel of the image, the image comprising a plurality of foreground figures and each of the plurality of foreground figures uniquely referenced by coordinate values relative to the image;
using a mixture model to identify a foreground cluster from a background cluster based on the RGB values;
segmenting the foreground cluster to obtain at least one foreground figure based on the particular coordinate value of each of the at least one foreground figure;
invoking a magnification feature of the electronic device to magnify the image at a foreground figure selected from the at least one foreground figure; and
positioning the magnified image by mapping a center coordinate of the selected foreground figure to the center of the display screen.

8. The storage medium as described in claim 7, wherein the mixture model is an expectation—maximization algorithm to cluster the image, and the expectation—maximization algorithm includes:
calculating a first similarity ratio between each pixel of the image and the foreground cluster, and a second similarity ratio between each pixel of the image and the background cluster;
sorting each pixel of the image into the foreground cluster or the background cluster according to the similarity ratios; and
adjusting each pixel of the image to sort the each pixel into a most possible cluster.

9. The storage medium as described in claim 7, wherein the method further comprises:
computing a center coordinate and a total area for each of the at least one foreground figure.

10. The storage medium as described in claim 9, wherein the foreground figure who has a largest total area is the selected foreground figure by default.

11. The storage medium as described in claim 9, wherein the foreground figure who has a smallest total area is the selected foreground figure by default.

12. The storage medium as described in claim 7, wherein the electronic device is a mobile phone, a personal digital assistant, a camera or a video camera.

13. An electronic device, comprising:
an adjusting unit and a display screen, the adjusting unit comprising:
a computing module operable to compute red green blue (RGB) values of each pixel of an image to be magnified, the image comprising a plurality of foreground figures and each of the plurality of foreground figures uniquely referenced by coordinate values relative to the image;
a clustering module operable to identify a foreground cluster from a background cluster based on the RGB values using a mixture model;
a segmentation module operable to segment the foreground cluster to obtain at least one foreground figure based on the particular coordinate value of each of the at least one foreground figure;
a magnifying module operable to invoke a magnification feature of the electronic device to magnify the image at a foreground figure selected from the at least one foreground figure;
a positioning module operable to position the magnified image by mapping a center coordinate of the selected foreground figure to the center of the display screen; and
at least one processor that executes the computing module, the clustering module, the segmentation module, the magnifying module, and the positioning module.

14. The electronic device as described in claim 13, wherein the mixture model is an expectation—maximization algorithm to cluster the image, the expectation—maximization algorithm includes:
calculating a first similarity ratio between each pixel of the image and the foreground cluster, and a second similarity ratio between each pixel of the image and the background cluster;
sorting each pixel of the image into the foreground cluster or the background cluster according to the similarity ratios; and
adjusting each pixel of the image to sort the each pixel into a most possible cluster.

15. The electronic device as described in claim 13, wherein the computing module is further operable to compute a center coordinate and a total area for each of the at least one foreground figure.

16. The electronic device as described in claim 14, wherein the foreground figure who has a largest total area is the selected foreground figure by default.

17. The electronic device as described in claim 14, wherein the foreground figure who has a smallest total area is the selected foreground figure by default.

18. The electronic device as described in claim 13, wherein the positioning module is further operable to adjust a display position of a displayed image that exceeds a display area of the display screen.

19. The electronic device as described in claim 13, wherein the electronic device is a mobile phone, a personal digital assistant, a camera or a video camera.
